(19) United States
(12) Patent Application Publication
(10) Pub. No.: US 2011/0017032 A1
(43) Pub. Date: Jan. 27, 2011

(54) VARIABLE TRIMMING EQUIPMENT, SYSTEMS, AND METHODS

(75) Inventors: Kenneth A. Hutchins, North Augusta, SC (US); Ricky G. Bullock, Mt. Vernon, IL (US)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: World Color Press Inc., Montreal, CA (US)

(21) Appl. No.: 12/759,965

(22) Filed: Apr. 14, 2010

Related U.S. Application Data
(60) Provisional application No. 61/227,115, filed on Jul. 21, 2009.

(51) Int. Cl. B26D 3/00; B26D 5/20

(52) U.S. Cl. 83/39; 83/213

(57) ABSTRACT

Trimming apparatus for books and similar materials are detailed. Dynamic variability of the apparatus allows sizes of successive materials to differ in two dimensions—both from spine to face and from head to foot. The result is a processing system with substantially greater utility than presently available, as the system may process respective materials of multiple different sizes without stopping the apparatus to adjust positions of the cutting implements.

### REFERENCE TO PROVISIONAL APPLICATION

This application is based on, claims priority to, and hereby refers to U.S. Provisional Patent Application Ser. No. 61/227,115, filed Jul. 21, 2009, entitled “Selective Head and Foot Trim,” the entire contents of which are incorporated herein by this reference.

### FIELD OF THE INVENTION

This invention relates to trimming items often referred to as “books” and more particularly, but not necessarily exclusively, to equipment, systems, and methods for variably processing bound collections of pages.

### BACKGROUND OF THE INVENTION

U.S. Patent Application Publication No. 2005/0016345 of Lorenzi discloses an exemplary “triple cutter” apparatus for use in processing “book blocks.” The apparatus includes “a front blade for performing a front edge trim in a first position of a book block and two lateral blades for performing a lateral edge trim in a second position of the book block.” See Lorenzi, p. 1, ¶ 0002. As described in the Lorenzi application, the book block
is initially moved . . . into a first cutting position relative to the front blade. After a front edge trim has been performed, the book block is moved into a second cutting position in relation to the two lateral blades. After a lateral blade trim has been performed, the book block is conveyed out of the triple cutter apparatus.
   See id., p. 3, ¶ 0032 (numerals omitted). Although the book block is conveyed through the apparatus, the positions of the lateral blades relative to each other are fixed. Consequently, the lateral size (i.e. height) of successive book blocks cannot be varied dynamically.

U.S. Pat. No. 5,823,934 to Ferrone describes another automatic trimming machine. The machine comprises both a preliminary trimming unit and a finish trimming unit, with the preliminary unit containing four knives rather than the conventional three. A first pair of knives trims “the left side of the folded paper” (i.e. the face of the paper) and its backbone, or spine, while the second pair trims “the top and bottom edges of the folded paper” (i.e. its head and foot). See Ferrone, col. 3, 11. 51-59; col. 4, 11. 22-24. After encountering the first pair of knives, the paper is directed at a right angle to its previous direction of transportation. Again, however, no change in relative position between (at least) the blades of the second pair of knives occurs, as the relative distance between the blades remains fixed. Accordingly, the distance between the head and foot of a paper will be the same for each paper trimmed.

### SUMMARY OF THE INVENTION

The present invention provides dynamic variability in spacing of knives of, principally, a triple cutter apparatus. The dynamic variability permits sizes of successive materials to differ in two dimensions—both from spine to face and from head to foot. The result is a processing system with substantially greater utility than presently available, as the system may process respective materials of multiple different sizes without stopping the equipment to change or adjust the knives.

This greater utility is especially (although not exclusively) important when creating catalogs, magazines, and direct mail pieces intended for transit via the United States Postal Service (USPS). USPS regulations currently provide postage discounts when pieces to be delivered on particular carrier routes are bundled together (“co-mailed”) by mailers. Because the pieces may have different sizes, they conventionally cannot be created and processed quickly by automated equipment, as the equipment cannot trim them to different heights without intermediate stoppage of the machinery. By contrast, the current invention facilitates co-mailing and it associated postage benefits by providing dynamic variability in knife spacing under computer control. Hence, pieces destined for the same carrier route (or other delivery grouping recommended by postal authorities) may be trimmed and processed sequentially and without interruption notwithstanding that they may be sized differently.

Presently-preferred versions of the invention operate on materials typically referred to as “books.” The materials normally comprise multiple printed sheets of paper bound on one side, with the bound side frequently referred to as the “spine.” The side opposite the spine is referred to as the “face” of the book, whereas its top side is the “head” and its bottom side is the “foot.” Although in many cases print on a sheet will be oriented so as to be read from “head” to “foot,” in other cases it may be oriented so as to be read from “foot” to “head”—or otherwise as appropriate or desired. Sets of pages within a book are sometimes referred to as “signatures” and may vary from book to book in number, size, and content. Catalogs and magazines are (non-limiting) examples of materials included as “books” as considered herein. “Books” conceivably could be formed without using paper, however, and (at least temporarily) might be bound on more than one side. They likewise need not necessarily be printed, although they preferably contain text, graphics, symbols, or other devices intelligible to humans or machines.

At least one embodiment of a triple cutter apparatus of the invention includes belts, clamps, or other conveying means for moving books from place to place. It additionally preferably includes a first knife having a blade oriented generally transverse to the local direction of transit. This first knife trims the face of each book to provide, typically, a uniform edge. A jogger may be employed to align feet of pages of a book against an associated guide prior to trimming of the face, following which second and third knives may be employed to trim the head and foot of the book, respectively. Blades of the second and third knives beneficially are oriented generally parallel to the local direction of movement of the book and are spaced apart from each other. Significantly, though, this spacing may change automatically as a function of time, so that the distance between the head and foot of one book may differ from that of the previous or succeeding book. After its head and foot are trimmed, each book may be conveyed to other equipment for further processing as appropriate or desired.

The position of the first knife may change dynamically relative to the widths of the untrimmed books. Hence, it may trim book faces at different distances from their spines. The second and third knives preferably are knives whose cutting motion beneficially (although not necessarily) is coordinated. In certain embodiments of the invention, the position of the third knife is fixed relative to the guide, so trimming of the foot of a book occurs at a fixed distance from its edge. By contrast, the position of the second knife may vary relative to the guide, allowing trimming of the head such that the distance from head to foot may vary from book to book. As a result, for a particular book, either or both of the distances between (1) its spine and face and (2) its head and foot may be different than the corresponding distances for a book trimmed immediately before or after it.

In certain versions of the invention, variably-positionable back stops may be employed to position books relative to the first knife. Under computer control, magnetic linear actuators (or other appropriate devices, including but not limited to pneumatic, electric, or hydraulic actuators) may move the back stops fore or aft along the longitudinal dimension of the conveyor depending on the desired width of the trimmed book. Mechanical pushers then push the spine of the book against the back stops, so that the first knife trims the face at the correct location. The back stops thereafter may be retracted below the level of the conveyor or otherwise repositioned so as not to inhibit advancement of each book toward the second and third knives.

One or more clamps optionally may be used to maintain page alignment as books advance through the system. Moreover, although presently-preferred versions of the invention use a fixed-position guide, the guide instead could itself be variably positioned. One or more controllers may, if desired, manage movement of any or all of the joggers, back stops, guide rails, and knives: Consistent with the invention, signals relating to (1) the untrimmed book size from head to foot (i.e. untrimmed height) may govern actuation of the jogger and guide rail, (2) the trimmed book size from spine to face (i.e. trimmed width) may govern positioning of the back stops, and (3) the trimmed book size from head to foot (i.e. trimmed height) may govern positioning of at least the second knife. Some of these signals additionally could be used to position either or both of the first and third knives.

An alternate embodiment of the invention employs two distinct trimmer assemblies. In the first assembly, only the face and foot are trimmed. Thereafter, a book is conveyed to the second assembly at which head trimming occurs. Alternatively, the face and head may be trimmed in the first assembly and the foot trimmed in the second assembly. Yet another alternative embodiment trims only the head or the foot in the first assembly, with the face and either the foot or the head trimmed in the second assembly.

It thus is an optional, non-exclusive object of the present invention to provide equipment, systems, and methods for trimming books.

It is an additional optional, non-exclusive object of the present invention to provide equipment, systems, and methods in which head-to-foot trim sizes may be varied automatically from book to book.

It is another optional, non-exclusive object of the present invention to provide equipment, systems, and methods in which spine-to-face trim sizes also may be varied automatically from book to book.

It is a further optional, non-exclusive object of the present invention to provide equipment, systems, and methods in which back stops are automatically moveable linearly and retractable.

It is, moreover, an optional, non-exclusive object of the present invention to provide equipment, systems, and methods in which at least one of a head-trimming or foot-trimming knife is automatically moveable.

It is also an optional, non-exclusive object of the present invention to provide equipment, systems, and methods in which a jogger likewise may be repositioned automatically from book to book.

It is yet another optional, non-exclusive object of the present invention to provide equipment, systems, and methods in which movement of any or all of the knifes, back stops, and joggers may be actuated using one or more magnetic linear actuators, servos, or other suitable means.

Other objects, features, and advantages of the present invention will be apparent to persons skilled in appropriate fields with reference to the remaining text and the drawings of this application.

### BRIEF DESCRIPTION OF THE DRAWINGS

FIG. 1 is a schematic representation of a conventional triple cutter apparatus as part of a book-trimming system.

FIG. 2 is a schematic representation of a version of the invention allowing face cuts to vary from book to book.

FIG. 3 is a schematic representation of the version of FIG. 2 also incorporating a jogger whose active position may vary from book to book.

FIG. 4 is a schematic representation of the version of FIG. 3 also incorporating a knife assembly allowing head-to-foot cuts to vary from book to book.

FIG. 5 is a schematic representation of a two-trimmer apparatus functional as an alternative to the version of FIG. 4.

### DETAILED DESCRIPTION

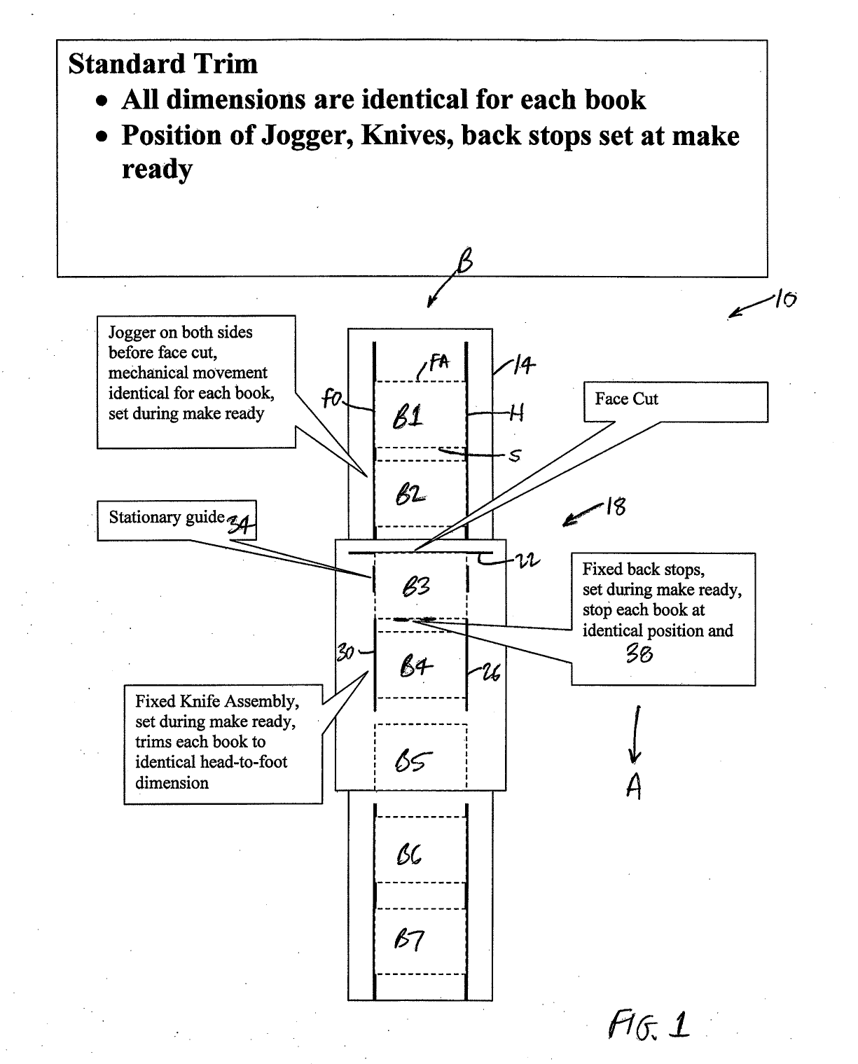

Illustrated in FIG. 1 are aspects of a conventional trimming system 10. System 10 may include belts 14 and other means for conveying books through triple cutter apparatus 18. As depicted for system 10, conveyance occurs linearly in the direction of arrow A in FIG. 1.

Conveyed continuously by belts 14 are books B, which are depicted in dotted lines in FIG. 1. Books B1 and B2 are untrimmed and shown as approaching first knife 22 for face trimming. Book B3 is being trimmed by first knife 22. Book B4 has been trimmed by first knife 22 and is being trimmed by respective second and third knives 26 and 30. Books B5-B7 have finished the trimming process and are being conveyed downstream for further processing. Each of books B is oriented such that spine S forms its leading edge, face FA forms its trailing edge, foot FO is adjacent guide 34, and head H is opposite foot FO.

System 10 additionally may include one or more joggers (not shown) and back stops 38. Movement of the joggers is determined prior to commencement of conveyance of books B and thereafter does not change. Likewise, the location of back stops 38 along direction A is determined prior to books B being conveyed by belts 14 and does not change dynamically. The distance between respective second and third knives 26 and 30 is also predetermined for a set of books B and does not change after conveyance begins, and guide 34 is stationary in system 10. Consequently, for a particular series of books B, each of books B1-B7 will have the same height and width, as (1) the distance from back stops 38 to first knife 22 is constant for the series, as is (2) the distance between second and third knives 26 and 30. If, for example, book B2 were desired to be trimmed to a size differing from book B5, system 10 would need to be stopped in order to adjust one or both of these otherwise-constant distances. Such stoppage obviously would decrease throughput of system 10, generally to a commercially-unacceptable level. Accordingly, books B to be trimmed to different sizes are not intermingled within system 10, even if doing so would decrease overall postage charges when the books B are mailed.

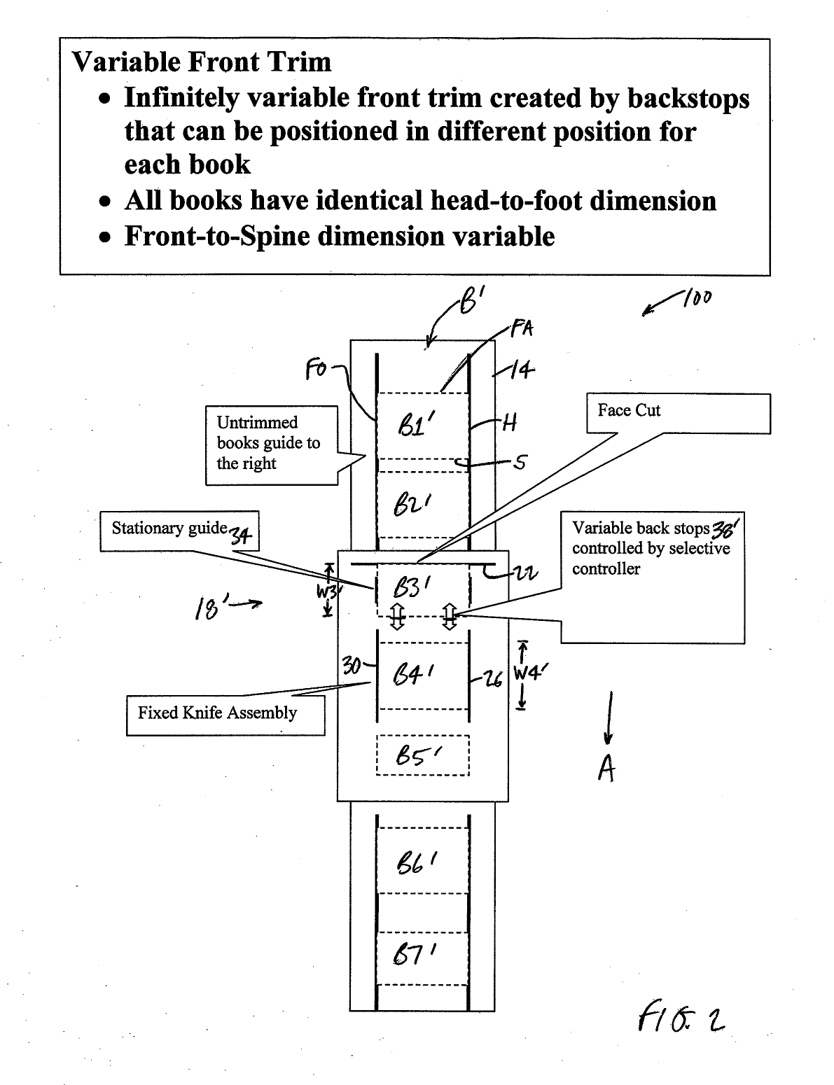

Systems 100, 200, and 300 of FIGS. 2-4 resolve this problem in whole or in part. Depicted in FIG. 2 are books B1′-B7′ of a set of books B′. Although the height of each of B1′-B7′ trimmed in system 100 will be the same, the width of each book may differ.

As with system 10, system 100 may include belts 14, clamps, or other means for conveying books B′ in the direction of arrow A. Stationary guide 34 too may be present as part of cutter apparatus 18′ of system 100, as may be joggers, first knife 22, second knife 26, third knife 30, and back stops 38′. For purposes of interpreting FIG. 2, books B′ may be oriented in the same manner as are books B of FIG. 1—spine S may form the leading edge and face FA the trailing edge, foot FO may be adjacent guide 34, and head H is opposite foot FO. Other orientations of books B′ are possible, however.

The relative positions of second and third knives 26 and 30 is adjusted only prior to operation of system 100, leading to the height of books B1′-B7′ being the same. By contrast, location of back stops 38′ along direction A may change dynamically from book to book in response to signals from a controller. Accordingly, the distance from back stops 38′ to first knife 22 may change from book to book, allowing each of books B1′-B7′ to have a different width when desired.

For example, assume book B4′ of FIG. 2 is a clothing catalog that has been trimmed by first knife 22 to a width W4′ from spine to face and ultimately is destined for delivery on a particular letter carrier route. Assume succeeding book B3′ likewise is destined for delivery on that same carrier route—and thus advantageously could be bundled together with book B4′ for postage discounts—but is a magazine needing to be trimmed to width W3′ that is less than W4′. To accomplish this result without stopping operation of system 100, back stops 38′ must be dynamically repositioned to be closer to first knife 22 than they were when the face of book B4′ was trimmed.

As occurs presently with some conventional systems 10, a controller may receive desired dimensions of books B′ and be programmed to receive information from sensors and track relative positions of books B′ within system 100. As part of this invention the controller may be programmed additionally so that, as it learns book B3′ is approaching apparatus 18′, it is able to determine that the desired width of book B3′ is less than that of book B4′ and signal back stops 38 to move opposite direction A to be closer to first knife 22. Such signaling preferably is received by one or more magnetic linear actuators connected to back stops 38—although other devices may be used instead—which in turn move back stops 38 to a distance from first knife 22 equal to width W3′. First knife 22 therefore may cut face FA of book B3′ to the correct width W3′ without stopping operation of system 100. Continuing with this example, if book B2′ is another clothing catalog of the type of book B4′, the controller then may signal actuators to return back stops 38 to their prior position so as to trim book B2′ to the same width as book B4′, again without ceasing operation of system 100.

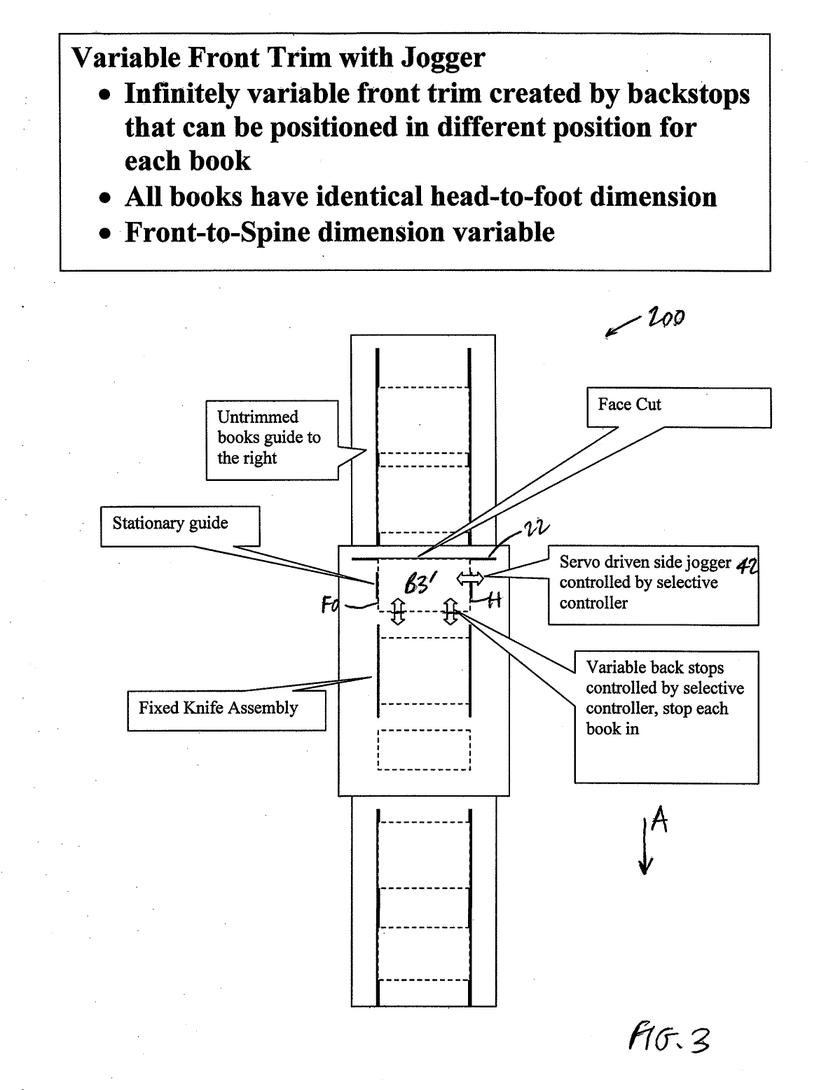

System 200 of FIG. 3 is generally similar to system 100. Additionally included as part of system 200, however, is jogger 42. Jogger 42 is designed to move in directions generally transverse to direction A so as to direct a book against guide 34, thereby aligning feet of pages of the book prior to any desired clamping of the book and face cutting by first knife 22. Because conventional trimming systems (such as system 10) process books of the same height, any jogger included as part of these systems need have only two positions: (1) a first, unactuated position in which it does not contact the book or impede its advancement through apparatus 18; and (2) a second, actuated position in which it bears against heads of pages of the book and forces the feet of the pages against guide 34. By contrast, jogger 42 is capable of assuming a multitude of positions, foreshadowing the fact that books of multiple heights may be trimmed continuously.

Important to proper actuation of jogger 42 is information concerning the untrimmed book size from head to foot (i.e. untrimmed height) of each book B′. This information thus desirably is provided to a controller tracking progress of books B′ through system 200. Knowing, for example, that book B3′ of approximate untrimmed height H3′ is positioned for face trimming by first knife 22, the controller may direct jogger 42 to move to a distance of approximately H3′ from guide 34. This movement of jogger 42 causes it to contact head H of book B3′ and push the book B3′ laterally so that its foot contacts guide 34. Presently-preferred versions of system 200 utilize one or more servo motors to control movement of jogger 42, although magnetic linear actuators or other motion-inducing means may be employed instead.

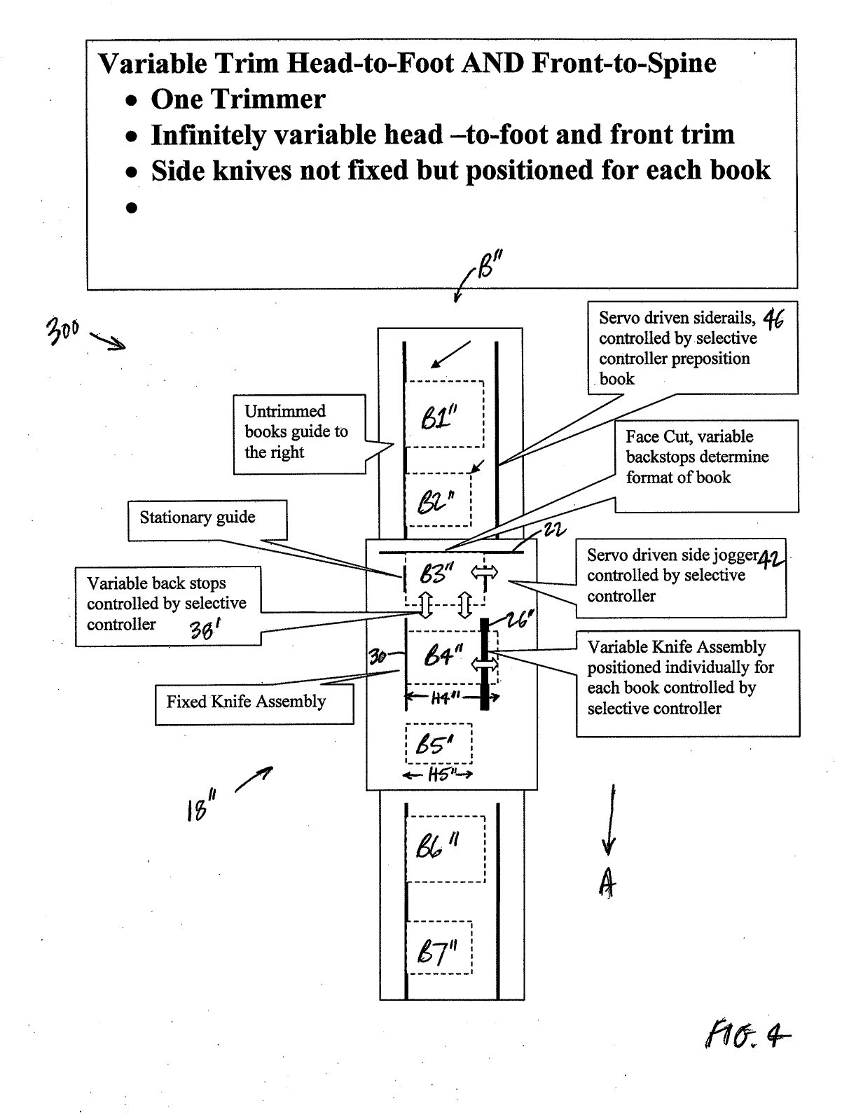

Detailed in FIG. 4 is system 300 of the present invention. System 300 is generally similar to system 200. However, in system 300, second knife 26″ may be repositioned dynamically relative to third knife 30, allowing books B″ to be trimmed to different heights as well without interrupting operation of the system 300. In particular, second knife 26″ may relocate laterally of direction A while, preferably, the position of third knife 30 remains constant. Persons skilled in relevant fields will, however, recognize that third knife 30 may move laterally of direction A either instead of or in addition to second knife 26″.

Assuming second knife 26″ indeed is moveable, as in FIG. 4, its movement may be controlled by a controller via signals to a magnetic linear actuator or other device (including but not limited to a pneumatic, electric, or hydraulic actuator) or a motor. Thus, for example, apparatus 18″ may trim book B5″ to a height H5″, following which book B4″ approaches second and third knives 26″ and 30 for trimming of its head H and foot FO. Assuming, consistent with FIG. 4, that the height H4″ of book B4″ is to be greater than the height H5″ of book B5″, second knife 26″ must be moved further away from third knife 30 than it was when book B5″ was trimmed. A controller signals for such movement, repositioning second knife 26″ at a distance H4″ apart from third knife 30. The second knife 26″ then trims head H of book B4″ while third knife 30 trims foot FO of the book B4″, producing a trimmed book B4″ of different height than trimmed book B5″. Hence, by also including variably-positioned back stops 38′ as part of system 200, the system 200 may be used continuously to trim books B″ of different heights and widths without stopping operation.

Additionally shown in FIG. 4 is rail 46. Rail 46 optionally may be moveable laterally of direction A so as to facilitate alignment of books B″ with guide 34. Movement of rail 46 may occur as a function of the height of an untrimmed book so as dynamically to vary the distance between rail 46 and guide 34 so that it approximates the height of an associated book. Servos signaled by a controller preferably effect movement of rail 46.

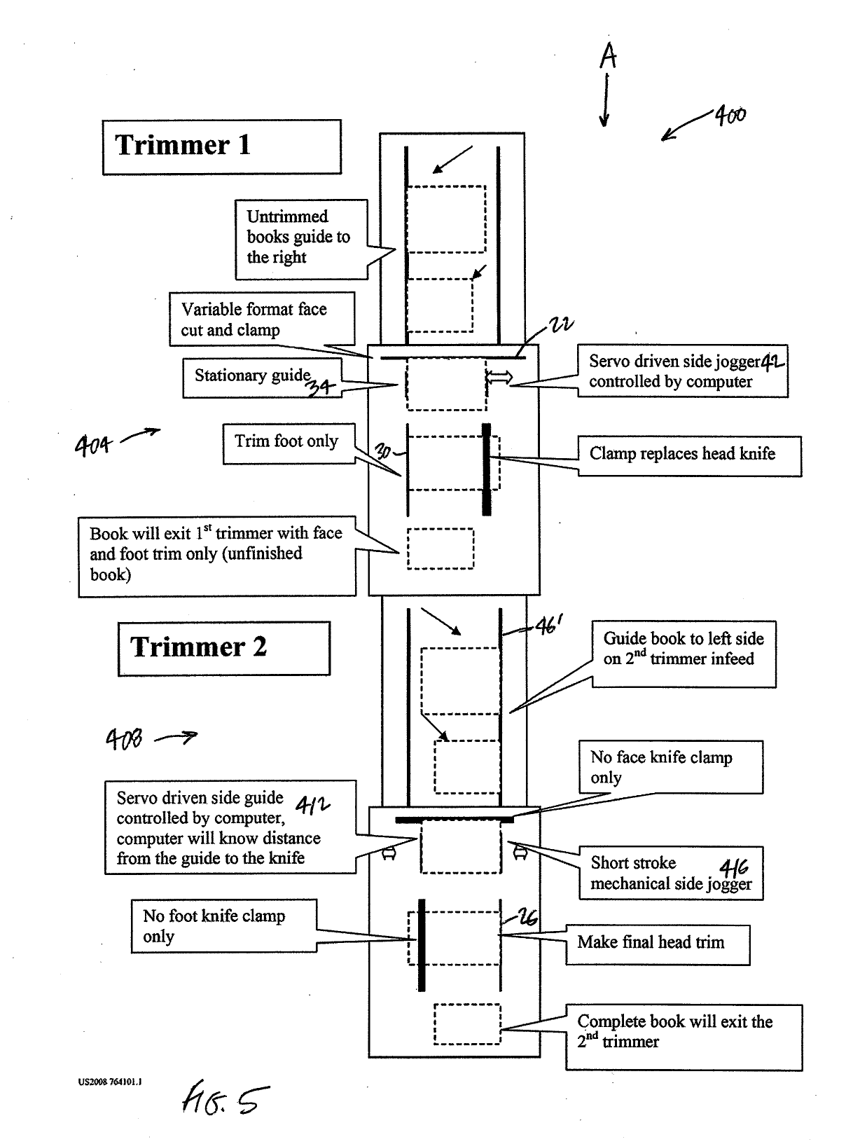

FIG. 5 depicts an alternate system 400 for producing books of different heights and widths. System 400 may include first cutter apparatus 404 and second cutter apparatus 408 downstream (in direction A) thereof. Like various prior systems, system 400 may include first knife 22, third knife 30, stationary guide 34, and jogger 42. It omits any second knife, however, instead simply clamping the head of each book while foot trimming occurs. As a consequence, each book exits first cutter apparatus 404 having had its face and foot trimmed but not its head.

After exiting first cutter apparatus 404, a book may enter second cutter apparatus 408 and be guided to rail 46′ opposite guide 34. Second cutter apparatus 408 includes variably-repositionable foot guide 412 as well as second knife 26 and jogger 416. A controller determines appropriate positioning of at least foot guide 412; together with jogger 416, foot guide 412 positions heads of books suitably under second knife 26 so as to produce a book of desired height. As noted earlier, though, two cutting operations may occur in second cutter apparatus 408 and only one in first cutter apparatus 404, for example, and the face, head, and foot of a book may be trimmed in any order and in any combination by any apparatus.

The foregoing is provided for purposes of illustrating, explaining, and describing embodiments of the present invention. Modifications and adaptations to these embodiments will be apparent to those skilled in the art and may be made without departing from the scope or spirit of the invention. The contents of the Lorenzi application and Ferrone patent are incorporated herein in their entireties by this reference.

What is claimed is:

1. A method of automatically trimming a series of books, comprising:
a. providing first and second books of the series of books, each book having a spine, a face opposite the spine, a head adjacent both the spine and the face, and a foot opposite the head;
b. sequentially conveying the first and second books to a cutter apparatus comprising at least two knives;
c. using at least one controller, positioning at least one of the at least two knives a first distance from another of the at least two knives, with the first distance being a desired height of the first book;
d. trimming the head and foot of the first book using the at least two knives so that the first book has a height equal to the first distance;
e. using the at least one controller, repositioning at least one of the at least two knives a second distance from another of the at least two knives, with the second distance being (i) a desired height of the second book and (ii) not equal to the first distance; and
f. trimming the head and foot of the second book using the at least two knives so that the second book has a height equal to the second distance.

2. A method according to claim 1 in which the cutter apparatus comprises first, second, and third knives and, after the head and foot of the first book are trimmed, the at least one controller repositions at least the second knife the second distance from the third knife.

3. A method according to claim 2 in which the at least one controller also repositions the third knife.

4. A method according to claim 2 further comprising:
a. using the at least one controller, positioning at least one back stop a third distance from the first knife, with the third distance being a desired width of the first book;
b. pushing the spine of the first book against the at least one back stop;
c. trimming the face of the first book using the first knife so that the first book has a width equal to the third distance;
d. using the at least one controller, repositioning the at least one back stop a fourth distance from the first knife, with the fourth distance being (i) a desired width of the second book and (ii) not equal to the third distance;
e. pushing the spine of the second book against the at least one back stop; and
f. trimming the face of the second book using the first knife so that the second book has a width equal to the fourth distance.

5. A method according to claim 4 further comprising:
using the at least one controller, positioning a jogger into contact with the head of the first book so as to push the foot of the first book against a stationary guide.

6. A method according to claim 5 further comprising:
using the at least one controller, positioning the jogger into contact with the head of the second book so as to push the foot of the second book against the stationary guide.

7. A method according to claim 6 in which the jogger is positioned differently when in contact with the head of the first book than when in contact with the head of the second book.

8. A method according to claim 7 in which the second knife trims the heads of the first and second books and the third knife trims the feet of the first and second books.

9. A method according to claim 8 in which at least one magnetic linear actuator electrically communicates with the at least one controller.

10. A method according to claim 9 in which the at least one magnetic linear actuator also electrically communicates with the second knife.

11. A method according to claim 10 in which the at least one magnetic linear actuator also electrically communicates with the at least one back stop.

12. A method according to claim 11 further comprising:
a. retracting the at least one back stop after the face of the first book is trimmed; and
b. conveying the first book to a location underneath the second and third knives.

13. A method of automatically trimming a series of books, comprising:
a. providing first and second books of the series of books, each book having a spine, a face opposite the spine, a head adjacent both the spine and the face, and a foot opposite the head;
b. sequentially conveying, on a conveying means, the first and second books to a cutter apparatus;
c. positioning at least one cutting implement of the cutter apparatus so as to trim the head and foot of the first book so that the first book has a height H1; and
d. without ceasing operation of the conveying means, repositioning the at least one cutting implement of the cutter apparatus so as to trim the head and foot of the second book so that the second book has a height H2 differing from H1.

14. A method of automatically trimming a series of books, comprising:
a. providing first and second books of the series of books, each book having a spine, a face opposite the spine, a head adjacent both the spine and the face, and a foot opposite the head;
b. sequentially conveying, on a conveying means, the first and second books to a first cutter apparatus;
c. trimming at least one of the face, head, and foot of the first book using the first cutter apparatus;
d. conveying the first book to a second cutter apparatus and, using at least one controller, actuating a moveable guide so as to position either the head or the foot of the first book relative to a knife of the second cutter apparatus;
e. using the knife, trimming whichever of the head or the foot of the first book was positioned by the moveable guide;
f. trimming at least one of the face, head, and foot of the second book using the first cutter apparatus;
g. conveying the second book to the second cutter apparatus and, using the at least one controller, actuating the moveable guide so as to position either the head or the foot of the second book relative to the knife; and
h. using the knife, trimming whichever of the head or the foot of the second book was positioned by the moveable guide so that the height of the second book differs from the height of the first book.

15. A system for automatically trimming at least first and second books, each book having a spine, a face opposite the spine, a head adjacent both the spine and the face, and a foot opposite the head, the system comprising:
a. a cutter apparatus comprising first, second, and third knives;
b. means for sequentially conveying the first and second books to the cutter apparatus; and
c. at least one controller configured to cause positioning of the second knife (i) a first distance from the third knife, with the first distance being a desired height of the first book, and (ii) thereafter a second distance from the third knife, with the second distance being (A) a desired height of the second book and (B) not equal to the first distance; and in which the head and foot of the first book are trimmed using the second and third knives so that the first book has a height equal to the first distance and the head and foot of the second book thereafter are trimmed using the second and third knives so that the second book has a height equal to the second distance.

16. A system for automatically trimming at least first and second books, each book having a spine, a face opposite the spine, a head adjacent both the spine and the face, and a foot opposite the head, the system comprising:
a. means for sequentially conveying the first and second books to a cutter apparatus having at least one cutting implement; and
b. means for (i) positioning the at least one cutting implement so as to trim the head and foot of the first book so that the first book has a height H1 and (ii) without ceasing operation of the conveying means, repositioning the at least one cutting implement so as to trim the head and foot of the second book so that the second book has a height H2 differing from H1.

17. A system for automatically trimming at least first and second books, each book having a spine, a face opposite the spine, a head adjacent both the spine and the face, and a foot opposite the head, the system comprising:
a. a first cutter apparatus configured to trim the face and foot of each of the first and second books;
b. a second cutter apparatus configured to trim the head of each of the first and second books and comprising a knife;
c. means for sequentially conveying the first and second books to the first cutter apparatus;
d. means for sequentially conveying the first and second books to the second cutter apparatus;
e. a moveable guide; and
f. at least one controller configured to position the moveable guide (i) a first distance from the knife, with the first distance being a desired height of the first book, and (ii) thereafter a second distance from the knife, with the second distance being (A) a desired height of the second book and (B) not equal to the first distance; and in which the head of the first book may be trimmed using the knife so that the first book has a height equal to the first distance and the head of the second book thereafter may be trimmed using the knife so that the second book has a height equal to the second distance.
